(19) United States
(12) Patent Application Publication
(10) Pub. No.: US 2015/0034599 A1
(43) Pub. Date: Feb. 5, 2015

(54) HIGH VOLTAGE INTERRUPTER UNIT WITH IMPROVED MECHANICAL ENDURANCE

(71) Applicant: ABB TECHNOLOGY AG, Zurich (CH)

(72) Inventors: Olaf Hunger, Schaffhausen (CH); Roman Good, Zurich (CH); Reto Karrer, Stafa (CH); Manuel Gotti, Turgi (CH); Francesco Pisu, Birmenstorf (CH); Jürg Nufer, Dubendorf (CH); Johan Costyson, Baden (CH); Jakub Korbel, Baden (CH); Roman Frei, Hinwil (CH); Florian Brandl, Zurich (CH); Jörg Becherer, Rikon im Tasstal (CH)

(73) Assignee: ABB TECHNOLOGY AG, Zurich (CH)

(21) Appl. No.: 14/445,116

(22) Filed: Jul. 29, 2014

(30) Foreign Application Priority Data
Aug. 5, 2013 (EP) 13179291.3

(51) Int. Cl. H01H 1/021; H01H 1/50

(52) U.S. Cl. CPC H01H 1/021; H01H 1/50; H01H 2235/01
USPC 218/146

(57) ABSTRACT

A high voltage interrupter unit includes a switching chamber within which at least two electric contact elements of a contact system are arranged to be moved relative to one another. The contact system includes at least one mechanical element which is at least in part not in fixed mechanical connection with either of the two contact elements. In order to increase the mechanical endurance of the contact system, the at least one mechanical element is sheathed at least in part in a layer of a synthetic, abrasion resistant material.

### RELATED APPLICATION(S)

This application claims priority under 35 U.S.C. §119 to European application 1317291.3 filed in Europe on Aug. 5, 2013, the entire content of which is hereby incorporated by reference.

### FIELD

The disclosure relates to a high voltage interrupter unit with a switching chamber within which at least two electric contact elements of a contact system can be arranged to be moved relative to one another and wherein the contact system includes at least one mechanical element which is at least in part not in fixed connection with either of the two contact elements.

### BACKGROUND INFORMATION

High voltage interrupter units can be used in circuit breakers and disconnectors of high voltage switchgear for interrupting a current flow. They are able to handle disconnecting currents of more than 10 kA and can be operated in a voltage range above 52 kV.

They contain a switching chamber which can be a vacuum chamber or filled with an insulating gas, such as SF6, and within the switching chamber, a high voltage interrupter unit contains two or more electric contact elements belonging to a contact system. The contact elements can be arranged to be moved relative to one another so that they can be moved from a closed contact position, where the current is flowing through the interrupter unit, to an open contact position, where the current flow is interrupted.

The movement of the at least two contact elements is commonly carried out along an axis.

Apart from the contact elements, an interrupter unit can contain elements, which do not have any contacting function, for example, they do not carry any electric current. Instead, they help to perform the movement of the contact elements, by interacting with at least one of them so that a mechanical force is applied to the at least one of the contact elements. By way of the mechanical force, parts of the respective contact element can for example be kept in place during the movement, or the contact element itself can be put into motion. In the following, these elements in the switching chamber, which belong to the contact system, are called mechanical elements.

### SUMMARY

A high voltage interrupter unit is disclosed, comprising: a switching chamber having at least two electric contact elements of a contact system that are arranged to be moved relative to one another, wherein the contact system includes at least one mechanical element which is at least in part not in fixed mechanical connection with either of the two contact elements, and wherein the at least one mechanical element is sheathed at least partly in a layer of a synthetic, abrasion resistant material.

### BRIEF DESCRIPTION OF THE DRAWINGS

The disclosure and its embodiments will become apparent from the example and its embodiments described below in connection with the appended drawings which illustrate:

FIG. 1 illustrates a switching chamber of an interrupter unit according to a known implementation;

FIG. 2 illustrates elements of a contact system according to an embodiment of the disclosure;

FIG. 3 illustrates the mechanical element of FIG. 2 according to an embodiment of the disclosure; and

FIG. 4 illustrates a section of the flexible sleeve around the mechanical element of FIG. 2 according to an embodiment of the disclosure.

### DETAILED DESCRIPTION

Exemplary embodiments of the present disclosure to provide a high voltage interrupter unit with improved mechanical endurance.

According to an exemplary embodiment of the disclosure, at least one of mechanical element of a contact system is sheathed, at least in part, in a layer of a synthetic, abrasion resistant material.

Mechanical elements which are not completely held in a fixed mechanical connection to the contact system and thereby to at least one of the contact elements, can be subject to abrasion. This is due to the fact that the part of the mechanical element which is not fixedly connected can rub against other elements of the contact system. A fixed mechanical connection can for example be a screw connection, a weld connection or a rivet connection.

Abrasion leads to the releasing of small particles within the switching chamber which can considerably reduce the dielectric strength in a high voltage interrupter unit.

By sheathing the mechanical element at least in part in a layer of a synthetic, abrasion resistant material, the level of abrasion can be considerably reduced, thereby increasing the mechanical endurance of the interrupter unit and the number of switching cycles of the interrupter unit before failure.

The layer of synthetic material can be arranged either as a flexible sleeve around the mechanical element or it can be applied in form of a surface coating. A flexible sleeve has the advantage that it leaves the mechanical characteristics of the mechanical element unchanged, while adapting to its shape. A surface coating can influence the mechanical characteristics to some extent, but it has the advantage that it fixedly attaches to its surface.

The flexible sleeve can for example be made of a band of the synthetic material which is wound spirally or helically around the mechanical element.

In an exemplary embodiment, the synthetic material is Polytetrafluoroethylene (PTFE). PTFE is suitable for gas-insulated switchgear due to its high chemical resistance. It resists both SF6 and its side products, for example hydrofluoric acid (HF). Advantages of PTFE can be its resistance against high and low temperatures, for example its resistance against heat in case of a short circuit.

According to another exemplary embodiment, a silicone elastomer can be used as the synthetic material.

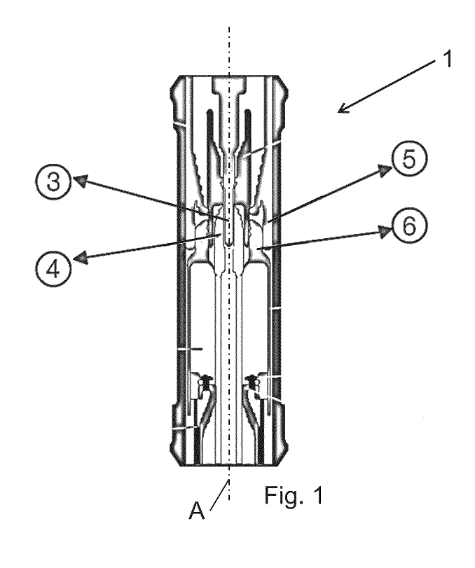

FIG. 1 shows a switching chamber 1 of a high voltage interrupter unit according to a known implementation. The switching chamber is arranged with rotational symmetry around a longitudinal axis A and contains in total four contact elements. Two of the four are stationary contact elements and the other two are movable contact elements. The movable contact elements can be moved along the axis A away from or towards the stationary contact elements. The so called main contact elements can be the stationary main contact element 5 and its counterpart, the moving main contact element 6. For handling arching effects which can occur during a disconnecting operation of the main contact elements 5 and 6, a stationary arcing contact element 3 and a moving arcing contact element 4 can be provided.

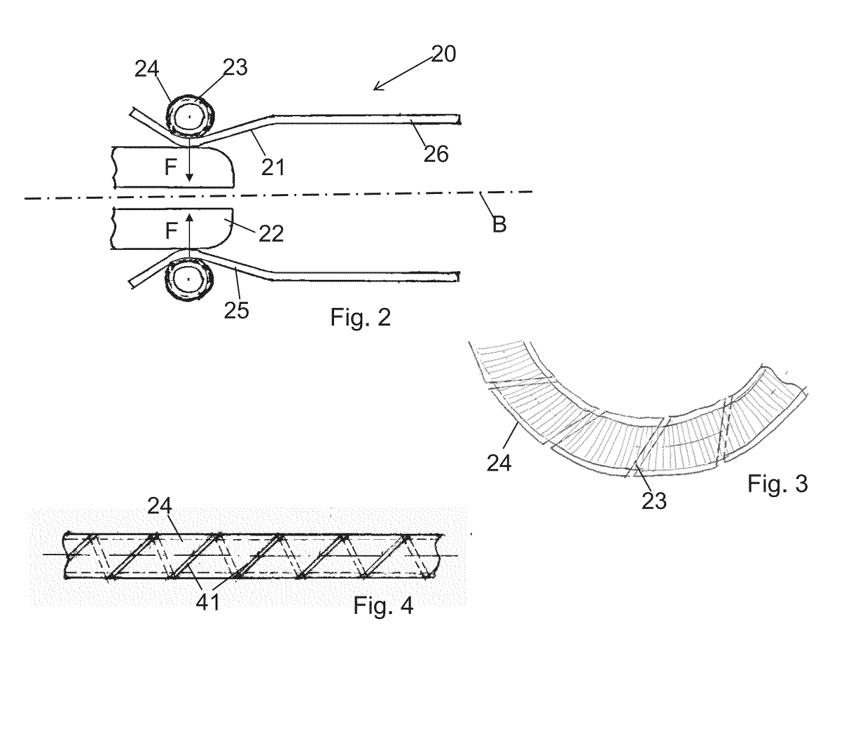

FIG. 2 illustrates elements of a contact system according to an embodiment of the disclosure. Namely, FIG. 2 shows the main contact elements of a contact system 20 and of a mechanical element 23. The contact system 20 is arranged with rotational symmetry around a longitudinal axis B inside a switching chamber of a high voltage interrupter unit. The switching chamber can be filled with vacuum or with an insulating gas, such as SF6, or a one-phase or two-phase dielectric medium, as described in WO 2010/142346, for example fluoroketone, for example C5-perfluoroketone and/or C6-perfluoroketone.

One of the main contact elements is an inner contact element 21 which is shown in direct physical contact with an outer contact element, wherein the outer contact element is arranged in the form of a hollow cylinder 26 around the longitudinal axis B, with the cylinder body 26 ending in a multiple of contact fingers, two of which are shown here as contact finger 22 and contact finger 25. The contact fingers can be aligned in parallel to one another and can be distributed along the circumference of the cylinder body 26.

In order to provide and ensure sufficient contact pressure between the contact fingers 22, 25 and the inner contact element 21, a spring element in the form of a coil spring 23 is wound around the cylinder body 26 of the outer contact element. The contact pressure of the spring element applies a force F to the contact fingers 22, 25 which is directed towards the longitudinal axis B of the outer contact element. The coil spring 23 does not carry any current but performs a purely mechanical function, e.g., it is a mechanical element of contact system 20. The coil spring 23 is held in its position solely by its own spring force, e.g., it is not fixedly connected.

During the moving of the contact elements against each other and due to vibrations and small movements of the coil spring 23 with respect to the contact fingers, particles can be released between the contact fingers 22, 25 and the coil spring 23 due to abrasion. These particles can pollute the switching chamber, resulting in a high risk for decreasing the dielectric strength in the high voltage interrupter unit.

To avoid the releasing of said particles, it is suggested according to the disclosure to sheathe the coil spring in a layer of a synthetic, abrasion resistant material. According to exemplary embodiments disclosed herein, the synthetic material includes materials resulting from a chemical reaction of artificial (e.g., non-natural) chemicals, such as plastics, synthetic fibers, synthetic rubber, synthetic resins, or any other suitable material as desired. The sheathing can be achieved by applying a surface coating. However, such a coating would considerably change the stiffness of the coil spring 23 thereby leading to efforts to redesign the overall arrangement of the spring.

According to an exemplary embodiment of the disclosure, it is suggested to arrange the layer of synthetic material as a flexible sleeve 24 around the coil spring 23. The flexible sleeve 24 is made of a band of the synthetic material which is wound spirally around the coil spring 23.

FIG. 3 illustrates the mechanical element of FIG. 2 according to an embodiment of the disclosure. FIG. 3 shows the coil spring 23 and how it peaks through equally distant gaps in a circular tube. The tube can be formed of the spirally wound band of the synthetic material and forming the flexible sleeve 24. Some of the windings of the coil spring 23 can also be recognized as a shadowy silhouette shining through the transparent material of sleeve 24.

FIG. 4 illustrates a section of the flexible sleeve around the mechanical element of FIG. 2 according to an embodiment of the disclosure. In FIG. 4, the flexible sleeve 24 with its equidistant gaps 41 is shown as a schematic diagram, wherein the sleeve 24 is not bent, thereby forming a straight tube.

By arranging the synthetic material in the form of a flexible sleeve, the stiffness of the spring, e.g., the spring constant, remains virtually unaffected, as the sleeve 24 adapts to the shape of the coil spring 23 almost without any resistance. Due to that, an accurate assembly of the contact system is possible.

In an exemplary embodiment, polytetrafluoroethylene (PTFE) can be selected as the synthetic abrasion resistant material of the sleeve 24. This is due to the fact that PTFE is resistant to high and low temperatures, for example resistant against heat in case of a short circuit. Further, it has a high chemical resistance against SF6 and its side products, for example hydrofluoric acid (HF).

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A high voltage interrupter unit, comprising:
a switching chamber having at least two electric contact elements of a contact system that are arranged to be moved relative to one another,
wherein the contact system includes at least one mechanical element which is at least in part not in fixed mechanical connection with either of the two contact elements, and
wherein the at least one mechanical element is sheathed at least partly in a layer of a synthetic, abrasion resistant material.

2. The high voltage interrupter unit according to claim 1, wherein the layer of synthetic material is arranged as a flexible sleeve around the mechanical element.

3. The high voltage interrupter unit according to claim 2, wherein the sleeve is made of a band of the synthetic material which is wound spirally or helically around the mechanical element.

4. The high voltage interrupter unit according to claim 1, wherein the layer of synthetic material is applied to the mechanical element as a surface coating.

5. The high voltage interrupter unit according to claim 1, wherein the synthetic material is polytetrafluoroethylene (PTFE).

6. The high voltage interrupter unit according to claim 2, wherein the synthetic material is polytetrafluoroethylene (PTFE).

7. The high voltage interrupter unit according to claim 3, wherein the synthetic material is polytetrafluoroethylene (PTFE).

8. The high voltage interrupter unit according to claim 4, wherein the synthetic material is polytetrafluoroethylene (PTFE).

9. The high voltage interrupter unit according to claim 1, wherein the synthetic material is a silicone elastomer.

10. The high voltage interrupter unit according to claim 2, wherein the synthetic material is a silicone elastomer.

11. The high voltage interrupter unit according to claim 3, wherein the synthetic material is a silicone elastomer.

12. The high voltage interrupter unit according to claim 4, wherein the synthetic material is a silicone elastomer.

13. The high voltage interrupter unit according to claim 1, wherein the at least one mechanical element is a spring element applying a contact pressure to one of the two contact elements.

14. The high voltage interrupter unit according to claim 13, wherein the spring element is a coil spring.

15. The high voltage interrupter unit according to claim 13, wherein the one of the two contact elements is arranged in the form of a hollow cylinder having a longitudinal axis, wherein the cylinder body ends in a multiple of contact fingers and wherein the contact pressure of the spring element applies a force to the contact fingers which is directed towards the longitudinal axis of the contact element.

16. The high voltage interrupter unit according to claim 14, wherein the one of the two contact elements is arranged in the form of a hollow cylinder having a longitudinal axis, wherein the cylinder body ends in a multiple of contact fingers and wherein the contact pressure of the spring element applies a force to the contact fingers which is directed towards the longitudinal axis of the contact element.
